(19) United States
(12) Patent Application Publication
(10) Pub. No.: US 2014/0119289 A1
(43) Pub. Date: May 1, 2014

(54) LINK SETUP IN WIRELESS NETWORK

(71) Applicant: NOKIA CORPORATION, Espoo (FI)

(72) Inventors: Mika IIkka Tapani Kasslin, Espoo (FI); Jarkko Lauri Sakari Kneckt, Espoo (FI)

(73) Assignee: Nokia Corporation, Espoo (FI)

(21) Appl. No.: 13/664,666

(22) Filed: Oct. 31, 2012

(51) Int. Cl. H04W 76/02

(52) U.S. Cl. 370/329

(57) ABSTRACT

This document relates to randomizing a timing of a channel access window in a wireless network. From the point of view of a terminal device, the terminal device receives from an access node a scanning frame indicating availability of the wireless network. After reception of the scanning frame, the terminal device determines a start time of a channel access window as a random or pseudo-random value and causes transmission of a link setup request frame from the terminal device to the access node during the determined channel access window.

### FIELD

The invention relates to the field of wireless communications and, particularly, to carrying out a link setup between a terminal device and an access point.

### BACKGROUND

A terminal device of a wireless communication system may be configured to scan for available access points before initiating a link setup with an access point of a wireless network. The terminal device may scan for scanning messages transmitted by the access points, wherein the scanning messages comprise parameters of the access point. Upon receiving such a scanning message, the terminal device may initiate a link setup.

### BRIEF DESCRIPTION

The invention provides an improved solution for said link setup in the wireless network.

According to an aspect, there is provided a method comprising: receiving, by a terminal device from an access node, a scanning frame indicating availability of a wireless network; after reception of the scanning frame, determining a start time of a channel access window as a random or pseudo-random value; and causing transmission of a link setup request frame from the terminal device to the access node during the determined channel access window.

According to another aspect, there is provided a method comprising: monitoring, in an access node of a wireless network, channel activity of a radio channel employed in the wireless network; determining at least one timing control parameter on the basis of the monitored channel activity, wherein a value of the at least one timing control parameter controls timing of at least one channel access window employed by at least one terminal device in transmission of a link setup request frame; and causing transmission of a frame comprising an information element carrying said at least one timing control parameter.

According to another aspect, there is provided an apparatus comprising at least one processor and at least one memory including a computer program code. The at least one memory and the computer program code are configured, with the at least one processor, to cause the apparatus to: acquire a scanning frame originating from an access node and indicating availability of a wireless network; upon acquiring the scanning frame, determining a start time of a channel access window as a random or pseudo-random value; and cause transmission of a link setup request frame to the access node during the determined channel access window.

According to yet another aspect, there is provided an apparatus comprising at least one processor and at least one memory including a computer program code. The at least one memory and the computer program code are configured, with the at least one processor, to cause the apparatus to: monitor channel activity of a radio channel employed in a wireless network; determine at least one timing control parameter on the basis of the monitored channel activity, wherein a value of the at least one timing control parameter controls timing of at least one channel access window employed by at least one terminal device in transmission of a link setup request frame; and cause transmission of a frame comprising an information element carrying said at least one timing control parameter.

According to yet another aspect, there is provided a method, comprising: receiving, by a terminal device from an access node, a scanning frame indicating availability of a wireless network; upon reception of the scanning frame, determining a transmission time of a link setup request frame to be transmitted from the terminal device as a first frame after said reception of the scanning frame, wherein the transmission time is a random or pseudo-random value computed by using at least one information element of the received scanning frame; and causing transmission of said link setup request frame from the terminal device to the access node.

In an embodiment, the at least one information element of the scanning frame used in the computation of the transmission time comprises a channel access window timing parameter, said determining the transmission time further comprising determining a start time of the channel access window by using at least the channel access window timing parameter.

In an embodiment, said determining the start time of the channel access window comprises: determining a deterministic part proportional to a time interval employed in the wireless network; determining a random or pseudo-random part; and computing the start time of the channel access window from the deterministic part and the random or pseudo-random part.

The random or pseudo-random part may be determined from at least one of an identifier of the terminal device, an identifier of the access node, and an identifier of the wireless network.

The deterministic part may be comprised in the received scanning message.

The time interval employed in the wireless network may be a beacon period.

In an embodiment, the at least one information element of the scanning frame used in the computation of the transmission time indicates a length of the channel access window.

In an embodiment, the at least one information element of the scanning frame used in the computation of the transmission time defines an access category for the link setup request frame, wherein the access category specifies a priority level of the link setup request frame.

In an embodiment, the method further comprises using the link setup request frame to request at least one of the following: to authenticate the terminal device in the access node; to create an association between the access node and the terminal device for frame transmissions; and to request, upon determining from the scanning frame that the access node has downlink data buffered for transmission to the terminal device, the access node to transmit at least one downlink data frame to the terminal device.

According to an aspect, any one of the above-described methods may be carried out by an apparatus comprising at least one processor and at least one memory including a computer program code, wherein the at least one memory and the computer program code are configured, with the at least one processor, to cause the apparatus to carry out the method.

According to an aspect, any one of the above-described methods may be carried out as a computer process defined by a computer program product embodied on a computer-readable distribution medium, wherein the computer program product configures a computer to carry out said computer process.

### LIST OF DRAWINGS

Embodiments of the present invention are described below, by way of example only, with reference to the accompanying drawings, in which

FIG. 1 illustrates an example of a wireless communication scenario to which embodiments of the invention may be applied;

FIG. 2 is a flow diagram of a procedure for determining a start time of a channel access window in a terminal device according to an embodiment of the invention;

FIG. 3 illustrates time distribution of channel access windows of terminal devices in an embodiment of the invention;

FIG. 4 is a flow diagram of a procedure for determining transmission timing of a link setup request frame in a terminal device according to an embodiment of the invention;

FIG. 5 illustrates a signaling diagram of a procedure for determining, signaling and utilizing parameters affecting timing of a link setup request frame in a wireless network according to an embodiment of the invention;

FIG. 6 illustrates a procedure for determining timing control parameters in an access node according to an embodiment of the invention;

FIG. 7 illustrates a procedure for randomizing a start time of the channel access window;

FIG. 8 is a flow diagram illustrating a procedure for determining timing of a request for contention-free frame transmission period in a terminal device according to an embodiment of the invention; and

FIGS. 9 and 10 illustrate block diagrams of structures of apparatuses according to some embodiments of the invention.

### DESCRIPTION OF EMBODIMENTS

The following embodiments are examples. Although the specification may refer to “an”, “one”, or “some” embodiment(s) in several locations, this does not necessarily mean that each such reference is referring to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

A general wireless communication scenario to which embodiments of the invention may be applied is illustrated in FIG. 1. FIG. 1 illustrates wireless communication devices comprising an access point (AP) 100 and a plurality of wireless terminal devices (STA) 102 to 114. The access point 100 may be associated with a basic service set (BSS) which is a basic building block of an IEEE 802.11 wireless local area network (WLAN). Each access point may represent a different BSS. The most common BSS type is an infrastructure BSS that includes a single AP together with all STAs associated with the AP. The AP may be a fixed AP, as in FIG. 1, or it may be a mobile AP and in the following description a node providing a terminal device with wireless connectivity is called an access node. The access node may provide access to other networks, e.g. the Internet. In another embodiment, the BSSs may be connected with each other by a distribution system (DS) to form an extended service set (ESS). An independent BSS (IBSS) is formed by an ad hoc network of terminal devices without a controlling access point, e.g. the terminal devices 102 to 114 without the access point 100. While embodiments of the invention are described in the context of the above-described topologies of IEEE 802.11, it should be appreciated that these or other embodiments of the invention may be applicable to networks based on other specifications, e.g. WiMAX (Worldwide Interoperability for Microwave Access), UMTS LTE (Long-term Evolution for Universal Mobile Telecommunication System), and other networks having cognitive radio features, e.g. transmission medium sensing features and adaptiveness to coexist with radio access networks based on different specifications and/or standards. Some embodiments may be applicable to networks having features under development by other IEEE task groups, e.g. 802.19 task group 1 (TG1).

IEEE 802.11n specification specifies a data transmission mode that includes 20 megahertz (MHz) wide primary and secondary channels. The primary channel is used in all data transmissions with clients supporting only the 20 MHz mode and with clients supporting higher bandwidths. A further definition in 802.11n is that the primary and secondary channels are adjacent. The 802.11 n specification also defines a mode in which a STA may, in addition to the primary channel, occupy one secondary channel which results in a maximum bandwidth of 40 MHz. IEEE 802.11 ac task group extends such an operation model to provide for wider bandwidths by increasing the number of secondary channels from 1 up to 7, thus resulting in bandwidths of 20 MHz, 40 MHz, 80 MHz, and 160 MHz. A 40 MHz transmission band may be formed by two contiguous 20 MHz bands, and an 80 MHz transmission band may be formed by two contiguous 40 MHz bands. However, a 160 MHz band may be formed by two contiguous or non-contiguous 80 MHz bands.

As mentioned above, the transmission band of a BSS contains the primary channel and zero or more secondary channels. The secondary channels may be used to increase data transfer capacity of a transmission opportunity (TXOP). The secondary channels may be called a secondary channel, a tertiary channel, a quaternary channel, etc. However, let us for the sake of simplicity use the secondary channel as the common term to refer also to the tertiary or quaternary channel, etc. The primary channel may be used for channel contention, and a TXOP may be gained after successful channel contention on the primary channel. Some IEEE 802.11 networks are based on carrier sense multiple access with collision avoidance (CSMA/CA) for channel access. Some networks may employ enhanced distributed channel access (EDCA) which provides quality-of-service (QoS) enhancements to medium access control (MAC) layer. The QoS enhancements may be realized by providing a plurality of access categories (AC) for prioritizing frame transmissions. The access categories may comprise the following priority levels in the order of increasing priority: background (AC_BK), best effort (AC_BE), video streaming (AC_VI), and voice (AC_VO). A higher priority frame transmission may use a shorter contention window and a shorter arbitration inter-frame spacing (AIFS) that result in higher probability of gaining the TXOP.

IEEE 802.11ai task group is creating principles for fast initial link setup (FILS). One aspect of the principles is to enable faster and more precise access node and network discovery. Some principles relate to passive scanning in which a scanning device, e.g. a STA, passively scans channels for any beacon, management, or advertisement frames. Other principles relate to active scanning in which the scanning device actively transmits a scanning request message, e.g. a Probe Request message or a generic advertisement service (GAS) request, in order to query for present access nodes or networks. The probe request may also set some conditions that a responding device should fulfill in order to respond to the probe request. In some embodiments, the scanning device may be called a requesting device or a requesting apparatus. Responding devices may transmit scanning response messages, e.g. Probe Response messages, in response to the scanning request message, wherein the scanning response message may contain information on the responding device, its network, and other networks. Embodiments of the scanning enhancements described herein encompass the network discovery signaling, probe request-response processes, as well as GAS request-response processes.

As described above, the BSS may be represented by the access node and one or more terminal devices connected to the access node. A terminal device 102 to 114 may establish a connection with any one of the access nodes it has detected to provide a wireless connection within the neighbourhood of the terminal device. The connection establishment may include authentication in which an identity of the terminal device is established in the access node. The authentication may comprise exchanging an encryption key used in the BSS. After the authentication, the access node and the terminal device may carry out association in which the terminal device is fully registered in the BSS, e.g. by providing the terminal device with an association identifier (AID). It should be noted that in other systems terms authentication and association are not necessarily used and, therefore, the association of the terminal device to an access node should be understood broadly as establishing a connection between the terminal device and the access node such that the terminal device is in a connected state with respect to the access node and scanning for downlink frame transmissions from the access node and its own buffers for uplink frame transmissions.

In areas where there are numerous terminal devices present within a coverage area of an access node, e.g. in airports and shopping malls, probability for that the transmissions of the terminal devices collide. Let us consider link setup as an example. A terminal device requiring wireless connectivity scans for the presence of wireless networks in its neighbourhood. Upon receiving a scanning frame, e.g. a beacon frame, a measurement pilot frame, or a probe response frame, it initiates a link setup by starting channel contention to transmit a link setup request frame. When one or more other terminal devices also preparing for the link setup receive the same scanning frame and start the channel contention at the same time with said terminal device, the probability of colliding link setup request frames increases. The link setup request frame may be a high priority frame utilizing a short contention window, which further increases the collision probability.

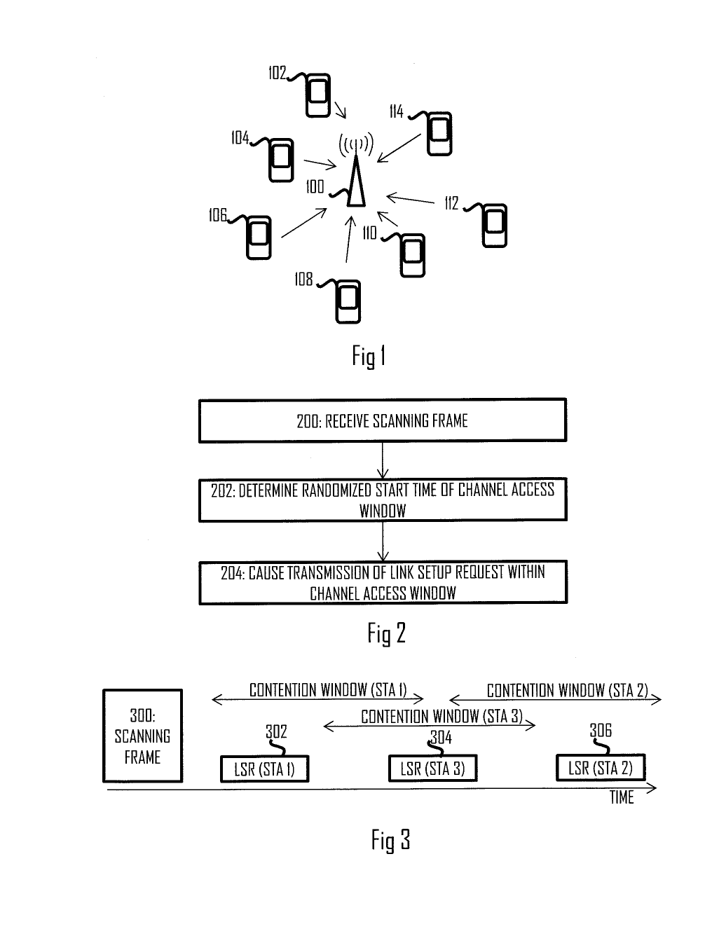

FIG. 2 illustrates an embodiment of a process for reducing the collision probability of link setup request frames. The reduction of the collision probability is based on configuring a terminal device to randomize a start time of a channel access window during which a terminal device may transmit the link setup request frame. Referring to FIG. 2, the terminal device receives a scanning frame indicating availability of a wireless network from an access node in block 200. The scanning frame may be a beacon frame, a measurement pilot frame, a pilot frame, or a scanning response frame. Examples of the scanning response frame comprise a probe response, a GAS frame, and a FILS response frame. After reception of the scanning frame, the terminal device determines a start time of a channel access window as a random or pseudo-random value (block 202). Upon determining the start time of the channel access window, the terminal device may wait until the channel access window opens and cause transmission of a link setup request frame to the access node during the determined channel access window (block 204).

Configuring the terminal devices to randomize the start time of their respective channel access windows results in that the channel access windows of different terminal devices are distributed in time and overlap only partially. On a system level, this increase in the time-span of the channel access windows effectively increases resources in which the link setup requests may be transmitted, which decreases the probability of collisions. FIG. 3 illustrates the effect of the randomization. Referring to FIG. 3, three terminal devices STA1, STA2, and STA3 are all simultaneously scanning for a wireless network to provide wireless connectivity. The terminal devices all receive the scanning frame 300 and, as a consequence, start to prepare for transmission of the link setup request message. The preparation comprises determining the channel access window. The channel access window may also be called a contention window in systems employing channel contention, e.g. the IEEE 802.11 networks. In the following, the term contention window is used. As a result of the randomized start times of the contention windows, the time intervals of the contention windows of the terminal devices are distributed over time such that the contention windows differ from one another. In this example, the contention windows of STA1 and STA3 overlap partially, while the contention windows of STA1 and STA2 do not overlap at all. Therefore, collision between STA1 and STA2 may be avoided certainly. The lengths of the contention windows of STA1, STA2, and STA3 may be equal or they may differ from one another, e.g. based on their respective access categories. The contention window of STA1 starts first and it may transmit its link setup request (LSR) frame 302 upon detecting that the channel is idle during its contention window. Upon detecting that the channel is busy, STA1 may backoff from the transmission and reattempt the transmission within the same contention window, if the channel becomes available. Similarly, STA2 and STA3 attempt transmission of their LSR frames 304, 306 during their respective contention windows. From the Figure, it is evident that the combined duration of the contention windows of STA1, STA2, and STA3 may be longer than the duration of a single contention window, thus increasing the resources for the LSR frames and reducing the probability of collisions. According to another point of view, the length of the contention window may be lowered while increasing the distribution. This increases the probability that the contention windows do not overlap at all and, the collision probability is accordingly reduced. The length of the contention window may be controlled by the access node by selecting the access category for the link setup request frames, as described herein.

In addition to randomizing the start time or, in general, the time interval of the channel access window, the terminal device may randomize the transmission time of the link setup request within the channel access window. As a consequence, the terminal device may wait for a random time interval after the start time of the channel access window before it makes a first attempt to transmit the link setup request.

In the above-described embodiments, the terminal device may determine the time interval between the reception of the scanning frame and the start time the channel access window autonomously without any control from the access node. In another embodiment, the access node controls the start time of the channel access window by inserting into the scanning frame at least one information element having a value that offsets the start time of the channel access window. Different values of the information element provide different offsets. The terminal device may then use this value when determining the timing of the channel access window.

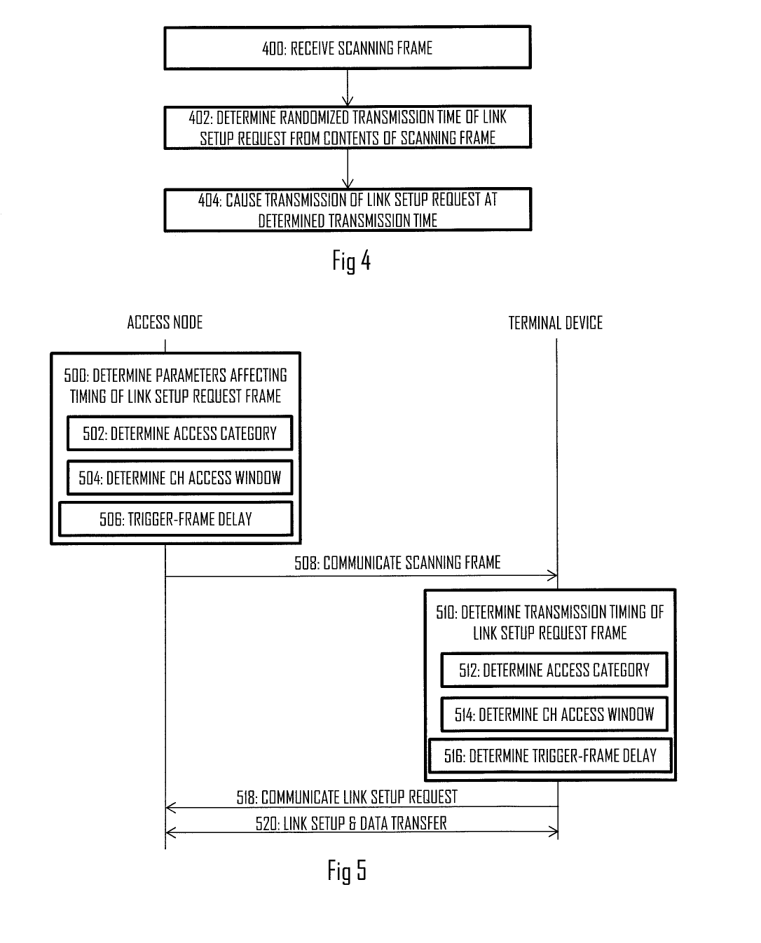

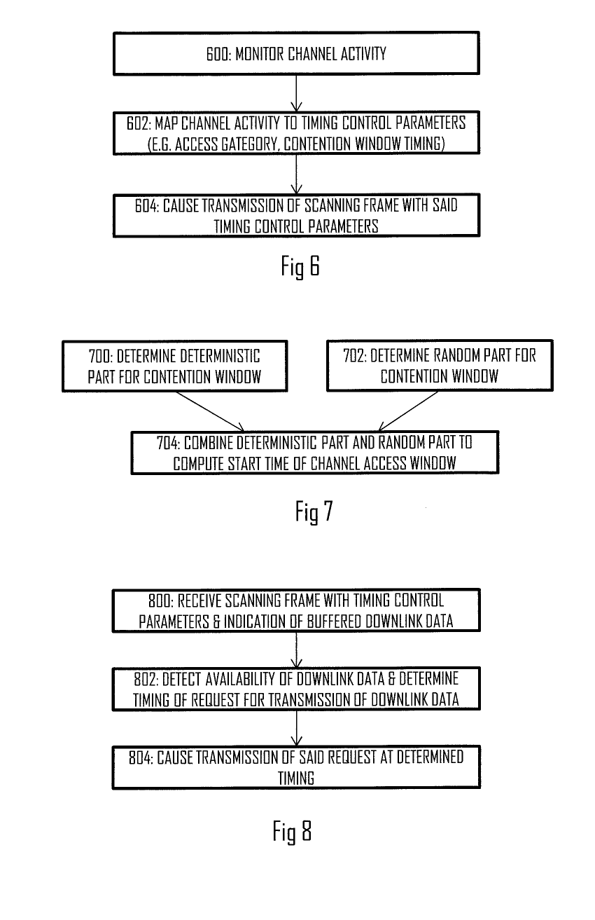

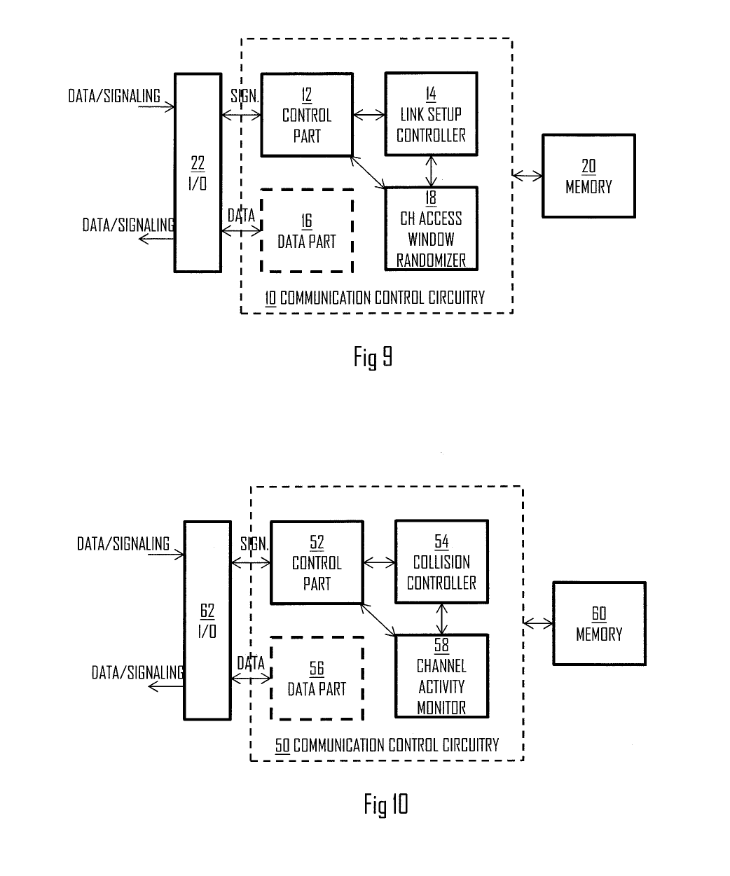

FIG. 4 illustrates another embodiment for reducing the collision probability. In this embodiment, the access node may control the transmission timing of the link setup requests, and the terminal device determines the transmission timing of the link setup request at least partly on the basis of at least one transmission timing parameter provided by the access node. Referring to FIG. 4, the terminal device receives the scanning frame from the access node in block 400. Upon reception of the scanning frame, the terminal device determines (block 402) a transmission time of a link setup request frame to be transmitted from the terminal device as a first frame after said reception of the scanning frame. The transmission time is a random or pseudo-random value computed by using at least one information element of the received scanning frame. In block 404, the transmission of the link setup request frame from the terminal device to the access node is carried out.

In this embodiment, the transmission timing of the link setup request is randomized, wherein at least some of randomization limits are defined by the at least one information element of the received scanning frame. The start time of the channel access window may also be randomized, as described above, or it may be deterministic.

Configuring the access node to control the transmission times of the link setup request enables use of an adaptation algorithm that may be used to control the collision probability according to congestion, for example. For example, it enables the access node to increase the time-span of the transmission times of the link setup requests in congested situations and to decrease the time-span when the network is not congested.

FIG. 5 illustrates a signaling diagram of an embodiment where the access node configures at least one parameter affecting the timing of the link setup request frames transmitted by the terminal devices that attempt to associate with the access node. Referring to FIG. 5, the access node determines such parameters in block 500. Block 500 may comprise determining at least one of an access category to be used in the link setup request frames (block 502), at least one timing control parameter of the channel access window for the link setup request frames (block 504), and/or whether or not to configure use of a trigger-frame delay (block 506). FIG. 6 illustrates an embodiment for carrying out block 500.

Referring to FIG. 6, the access node monitors channel activity of a channel of its BSS in block 600, e.g. a primary channel of the BSS. In an embodiment, the channel activity is measured in connection with carrying out channel contention. The access node may have a backoff value which determines a time duration for the channel to be idle before the access node may access the channel. When the channel is sensed to be idle, the backoff value is reduced at a determined rate. The reduction rate may be determined by the access category the access node uses for the channel access. When the channel is sensed to be busy, the backoff reduction may be halted. Now, the channel activity monitoring may be carried out by computing how many times it is able to reduce its backoff value within a determined time window, e.g. a beacon interval or a shorter time interval. A low number of backoff reductions or slow progress of backoff reduction indicates high channel activity while a high number of backoff reductions or fast progress of the backoff reduction indicates that the channel is relatively free. It should be appreciated that other methods may be used as well, e.g. monitoring a ratio between idle periods and busy periods of the channel.

The access node may determine in block 600 additionally periodicity of the busy intervals of the channel. For example, if a periodicity pattern is detected, e.g. with a period between 20 ms and 40 ms, the access node may determine that the BSS is synchronized for real-time application transmission (video or voice). If no periodicity is detected, the access node may determine that terminal devices currently associated with the access node transfer best effort or background traffic.

Block 600 may additionally comprise determining a congestion level from the channel activity. The congestion level may be determined directly from the channel activity by evaluating the amount of busy intervals with respect to the idle intervals. In block 602, the channel activity and/or the congestion level is/are mapped to timing control parameters. The timing control parameters may specify at least one of the above-mentioned access category, timing control for the channel access window, and the trigger-frame delay. In block 604, the access node causes transmission of a frame comprising the timing control parameters. The frame may be the above-mentioned scanning frame or another management frame, e.g. an association response or an authentication response.

In an embodiment, the access node maps the channel activity, e.g. the number of backoff reductions, to the access category to be used by the terminal devices for the link setup request frames. This may be carried out by counting the number of backoff reductions with the highest priority access category (AC_VO or AC_{—}3 in 802.11 networks) and mapping the number of counted backoff reductions to the access category such that the higher the number of backoff reductions, the higher the selected access category. For example, if the number of counted backoff reductions is below a first threshold TH1, the selected access category is the lowest access category (AC_BK). If the number of counted backoff reductions is above TH1 but below a second threshold TH2, the selected access category is the second lowest access category (AC_BE),If the number of counted backoff reductions is above TH2 but below a third threshold TH3, the selected access category is the third lowest access category (AC_VI). If the number of counted backoff reductions is above TH3, the selected access category is the fourth lowest access category (AC_VO).

In an embodiment, the access node maps the channel activity or the congestion level to at least one timing parameter controlling the timing and/or timing distribution of the channel access windows of the terminal devices. As described above, the channel access window timing may be a random or a pseudo-random parameter. The channel access window timing may be comprised of a deterministic part provided by the access node and a random or pseudo-random part determined by the terminal device itself. The deterministic part may be understood to scale or shift the channel access windows of the terminal devices in the time domain. The same deterministic part comprised in the scanning frame may be used by the multiple terminal devices. The deterministic part may be presented in terms of a time interval employed by the wireless network. In an embodiment, the duration specified by the deterministic is presented in units of a beacon interval. Table 1 below illustrates an embodiment of a field comprised in the scanning frame to define the deterministic part.

TABLE 1

| Field Value | Duration of Deterministic Part |
|---|---|
| “00” | 2 x Beacon Interval |
| “01” | Beacon Interval |
| “10” | ½ Beacon Interval |
| “11” | ¼ Beacon Interval |

In an embodiment, the access node maps the channel activity to the selection of whether or not to employ transmission delay in connection with the trigger-frame. The trigger-frame may be used as a request frame for the terminal device to request for the access node to transmit downlink data buffered in the access node for the terminal device. The downlink data transmission triggered by the trigger-frame may be carried out in a contention-free state. In general, the trigger frame may be used to initiate a contention-free period for transferring at least one data frame between the terminal device and the access node. The terminal device may employ a power-save mode in which it periodically wakes up to scan for the scanning frame. The scanning frame (the beacon frame, for example) may comprise a traffic indication map (TIM) comprising information on whether or not the access node has buffered downlink data for the terminal device. If the terminal device detects from the TIM that there is downlink data available, it may transmit the trigger frame. The trigger frame may be understood as one form of the link setup request in which the terminal device requests the access node to switch the link from a buffering state to a downlink transmission state. With the terminology of IEEE 802.11 networks, the trigger frame may be a Power-save Poll frame or an Automatic Power-Save Delivery (APSD) frame. The trigger-frame delay parameter may specify whether or not the access node configures the terminal devices to delay the transmission of the trigger frame in order to reserve capacity for the other link setup requests, e.g. association requests and authentication requests. A field of the timing control parameter specifying the delay for the trigger-frame may comprise only one bit for switching the delay on/off.

In an embodiment, the periodicity of the busy intervals of the channel may be used to disable the immediate transmission of the link setup requests in connection with some scanning frames. For example, if the channel activity monitoring indicates that the channel will be busy right after the transmission of the next periodic beacon frame, the access node may configure the terminal devices about to send the link setup request to delay the transmission of the link setup request in order to avoid collisions. On the other hand, if the access node determines that the channel will be relatively free after the beacon frame, the access node may allow the immediate link setup requests. The disabling of the transmissions of the link setup requests may be configured by using a one-bit indicator in the scanning frame, wherein one value disables the link setup request frame creation after the reception of the scanning frame in the terminal device, while another value allows the creation of the link setup request frame.

Referring now back to FIG. 5, the access node transmits the scanning frame in 508. The transmission may be a broadcast transmission. The scanning frame may comprise a collision control information element illustrated in Table 2:

TABLE 2

| Type/ID | Length | Collision Control |
|---|---|---|
| 1 octet | 1 octet | 1 octet |

The Type/ID field may identify the collision control information element in the scanning frame, and the Length field may specify the length of the collision control information element. The collision control field may carry out the payload of the information element, and it may comprise at least some of the sub-fields illustrated in Table 3:

TABLE 3

| | Random | Deterministic | Trigger-frame | |
|---|---|---|---|---|
| AC | window on/off | part | delay | Reserved |
| 2 bits | 1 bit | 2 bits | 1 bit | 2 bits |

The AC sub-field may indicate the access category for the link setup request frames, and it may also be called AC for FILS Frames. The random window on/off may indicate whether or not to use the randomization of the start time of the channel access window, and it may also be called FILS Frame Randomization Field. The deterministic part may comprise the deterministic part for the randomization of the start time of the channel access window, and it may also be called FILS Randomization Value. The trigger-frame delay sub-field may indicate whether or not to disable the link setup request creation in response to the scanning frame in the terminal devices receiving the scanning frame, and it may also be called Trigger Frame Randomization sub-field.

Upon receiving the scanning frame in 508, the terminal device extracts the collision control information element from the scanning frame. The terminal device may identify the collision control information element from the Type/ID field. The terminal device may then determine the transmission timing of the link setup request frame at least partly on the basis of the collision control information element in block 510. Block 510 may comprise determining the access category for the link setup request (block 512). The access category may affect the length of the contention window, the length of the AIFS, and/or the backoff reduction rate during the contention, for example. Block 510 may comprise determining the timing of the channel access window (block 514). Block 514 may comprise determining from the sub-field “Random window on/off” whether the contention window starts at default timing after the reception of the scanning frame or whether the start time is to be randomized. If the default timing is used, the terminal device may start the channel contention at the default timing. If the randomization is used, the terminal device may use the deterministic part comprised in the scanning frame in determining the randomized start timing for the contention window.

FIG. 7 illustrates an embodiment for randomizing the start time of the contention window. In block 700, the terminal device reads the deterministic part from the received scanning frame. In block 702, the terminal device determines a random part for the start timing of the contention window. The random part may be computed from at least one of an identifier of the terminal device, an identifier of the access node from which the scanning frame was received, and an identifier of the BSS of the access node. The terminal device may use a subset of the bits of any one of the identifiers, and it may use one or more identifiers. In an embodiment, the random part is formed by summing the subsets of bits acquired from multiple identifiers, e.g. the BSS identifier and an identifier of the terminal device, e.g. a medium access control address and by computing a modulus four (4) from the resulting sum. Other methods for mapping the identifier or a combination of identifiers into another value, e.g. an integer value, may be used.

The start time of the channel access window may be determined by combining the deterministic part and the random part (block 704). In an embodiment, the deterministic part is scaled by the random part by multiplying the deterministic part by the random part.

It should be appreciated that the end time of the channel access window may be computed in a similar manner, or it may be derived directly from the start time by adding the length of the channel access window to the start time. The length of the channel access window may be derived from the access category of the link setup request (block 512).

When the terminal device applies the power-save mode and uses the scanning frame to read the TIM, the terminal device may carry out block 516 if the TIM of the received scanning frame indicates the availability of downlink data for the terminal device. In block 516, the terminal device determines whether the request for the transmission of the downlink data may be sent immediately or after a while. FIG. 8 illustrates an embodiment of block 516. In block 800, the terminal device receives the scanning frame with the TIM element. In block 802, the terminal device detects the availability of the downlink data buffered in the access node from the TIM element. Then, the terminal device determines from the trigger-frame delay sub-field of the collision control element of the received scanning frame whether the terminal device may proceed to transmit the request for transmission of the downlink data or whether it should postpone the request. Upon determining the possibility to transmit the request immediately, the terminal device may start the channel contention immediately after the reception and processing of the scanning frame. On the other hand, if the trigger-frame delay field indicates that the transmission of the trigger frame is disabled, the terminal device may stand by for a determined time interval. The determined time interval may be a randomized time interval which may last longer than a default channel contention window that would be used if the immediate trigger frame transmission would be enabled by the value of the trigger-frame delay sub-field. In an embodiment, the determined time interval is a beacon interval, e.g. the terminal device may wait for the reception of the subsequent scanning frame and then determine again from the trigger-frame delay sub-field of the new scanning frame whether or not the disabling is still valid. The request is transmitted in block 804.

Referring back to FIG. 5, upon determining the transmission timing for the link setup request frame, the terminal device transmits and the access node receives the link setup request frame in 518. In 520, link setup is performed and data is transferred between the terminal device and the access node.

FIG. 9 illustrates an embodiment of an apparatus comprising means for carrying out the above-mentioned functionalities of the terminal device. The terminal device may comply with specifications of an IEEE 802.11 network or another wireless network, e.g. it may be a STA. The terminal device may also be a cognitive radio apparatus capable of adapting its operation to a changing radio environment, e.g. to changes in parameters of another system on the same frequency band. The terminal device may be or may be comprised in a computer (PC), a laptop, a tablet computer, a cellular phone, a palm computer, or any other wireless apparatus provided with radio communication capability. In another embodiment, the apparatus carrying out the above-described functionalities of the terminal device is comprised in such a wireless apparatus, e.g. the apparatus may comprise a circuitry, e.g. a chip, a processor, a micro controller, or a combination of such circuitries in the wireless apparatus.

Referring to FIG. 9, the apparatus may comprise a communication controller circuitry 10 configured to control wireless communications in the terminal device. The communication controller circuitry 10 may comprise a control part 12 handling control signaling communication with respect to transmission, reception, and extraction of control or management frames including the scanning request messages, scanning response messages, beacon frames, measurement pilot frames, or any other frames transmitted between access points and terminal devices, as described above. The communication controller circuitry 10 may further comprise a data part 16 that handles transmission and reception of payload data when the terminal device is associated to an access point. The communication control circuitry 10 may further comprise a link setup controller circuitry 14 configured to control link setup and associated transmission of link setup request messages. When an application is requesting for a setup of a link to a wireless network, the link setup controller circuitry 14 is called to establish the link. The link setup controller circuitry 14 may then configure the control part 12 to scan channels for scanning frames. Upon reception of a scanning frame, the link setup controller circuitry 14 may determine whether or not default timing is allowed for the transmission of a link setup request message. If the default timing is allowed, the link setup controller circuitry 14 may configure the control part to carry out default channel contention which may comprise scanning the channel for a determined period of time before transmitting the link setup request, if the channel is sensed to be free. The determined period of time may comprise a randomized backoff time. If the link setup controller circuitry determines that there are special rules with respect to the transmission timing of the link setup request, the link setup controller circuitry may derive the rules from the received scanning frame. If the rules comprise randomization of the timing of the channel contention window, the link setup controller may call a channel access window randomizer 18 to determine the timing of the contention window. Upon determining the timing of the channel access window, the channel access window randomizer may output the timing to the control part 12, and the control part 12 may start the channel contention for the transmission of the link setup request frame when the channel access window starts. Similarly, the link setup controller circuitry may determine the access category of the link setup request or whether or not trigger-frame delay is applied, if the link setup request is the above-described trigger frame.

The circuitries 12 to 18 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 12 to 18 or all of them.

The apparatus may further comprise the memory 20 that stores computer programs (software) configuring the apparatus to perform the above-described functionalities of the terminal device. The memory 20 may also store communication parameters and other information needed for the wireless communications, e.g. information of previously discovered wireless networks. The apparatus may further comprise radio interface components 22 providing the apparatus with radio communication capabilities within one or more wireless networks. The radio interface components 22 may comprise standard well-known components such as an amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention in the wireless device comprises at least one processor and at least one memory including a computer program code, wherein the at least one memory and the computer program code are configured, with the at least one processor, to cause the apparatus to carry out the functionalities of the terminal device according to any one of the embodiments of FIGS. 2 to 5, 7, and 8. Accordingly, the at least one processor, the memory, and the computer program code form processing means for carrying out embodiments of the present invention in the terminal device.

FIG. 10 illustrates an embodiment of an apparatus comprising means for carrying out the above-mentioned functionalities of the access node. The access point may be a wireless device which complies with specifications of an IEEE 802.11 network or another wireless network. The wireless apparatus may also be a cognitive radio apparatus capable of adapting its operation to a changing radio environment, e.g. to changes in parameters of another system on the same frequency band. The wireless device may be or may be comprised in a computer (PC), a laptop, a tablet computer, a cellular phone, a palm computer, a base station with routing functionalities, or any other apparatus provided with radio communication capability. The wireless device may be the access point or a non-access point terminal device with the access point functionalities, e.g. internet connection sharing functions. In another embodiment, the apparatus carrying out the above-described functionalities of the access point is comprised in such a wireless device, e.g. the apparatus may comprise a circuitry, e.g. a chip, a processor, a micro controller, or a combination of such circuitries in the wireless device.

Referring to FIG. 10, the apparatus may comprise a communication controller circuitry 50 configured to control wireless communications in the wireless device. The communication controller circuitry 50 may comprise a control part 52 handling control signaling communication with respect to transmission, reception, and extraction of control or management frames including the beacon frames, measurement pilot frames, probe response or scanning response frames, link setup requests, and GAS frames, as described above. The communication controller circuitry 50 may further comprise a data part 56 that handles transmission and reception of payload data with terminal devices associated to the access node. The communication controller circuitry 50 may further comprise a channel activity monitor circuitry 58 configured to monitor the channel activity and/or the congestion level of the channel. The channel activity monitoring may be carried out by monitoring normal procedures of the access node, e.g. the channel contention and associated backoff reductions within a determined time window. The channel activity monitor circuitry 58 may output the results to a collision controller circuitry 54.

The collision controller circuitry 54 may determine the timing control of the link setup requests transmitted by the terminal devices in the wireless network of the access node. The collision controller circuitry 54 may map the channel activity and/or the congestion level into a set of timing control parameters that are used to control the timing distribution of the link setup request frames. The collision control circuitry may thus create the collision control information element described above and output the information element to the control part 52. The control part 52 may then include the information element in the next scanning frame it transmits.

The circuitries 52 to 58 of the communication controller circuitry 50 may be carried out by the one or more physical circuitries or processors. In practice, the different circuitries may be realized by different computer program modules. Depending on the specifications and the design of the apparatus, the apparatus may comprise some of the circuitries 52 to 58 or all of them.

The apparatus may further comprise the memory 60 that stores computer programs (software) configuring the apparatus to perform the above-described functionalities of the access node. The memory 60 may also store communication parameters and other information needed for the wireless communications within a wireless network of the access node and with other wireless networks. The memory may store a neighbour database comprising information on neighbouring wireless networks. The apparatus may further comprise radio interface components 62 providing the apparatus with radio communication capabilities within its wireless network and/or with other wireless networks. The radio interface components 62 may comprise standard well-known components such as an amplifier, filter, frequency-converter, (de)modulator, and encoder/decoder circuitries and one or more antennas. The apparatus may further comprise a user interface enabling interaction with the user of the device. The user interface may comprise a display, a keypad or a keyboard, a loudspeaker, etc.

In an embodiment, the apparatus carrying out the embodiments of the invention in the wireless apparatus comprises at least one processor and at least one memory including a computer program code, wherein the at least one memory and the computer program code are configured, with the at least one processor, to cause the apparatus to carry out the functionalities of the access node according to any one of the processes described above with respect to FIGS. 5 and 6. Accordingly, the at least one processor, the memory, and the computer program code form processing means for carrying out embodiments of the present invention in the access node.

As used in this application, the term ‘circuitry’ refers to all of the following: (a) hardware-only circuit implementations, such as implementations in only analogue and/or digital circuitry, and (b) to combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) to circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular element, a baseband integrated circuit or applications processor integrated circuit for a wireless device.

The processes or methods described in connection with FIGS. 2 to 8 may also be carried out in the form of one or more computer processes defined by respective one or more computer programs. The computer program may be in source code form, object code form, or in some intermediate form, and it may be stored in a transitory or a non-transitory carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to wireless networks defined above but also to other suitable wireless communication systems. The protocols used, the specifications of wireless networks, their network elements and terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method comprising:
receiving, by a terminal device from an access node, a scanning frame indicating availability of a wireless network;
after reception of the scanning frame, determining a start time of a channel access window as a random or pseudo-random value; and
causing transmission of a link setup request frame from the terminal device to the access node during the determined channel access window.

2. The method of claim 1, further comprising determining the start time of the channel access window by using a value of at least one information element of the received scanning frame.

3. The method of claim 1, wherein said determining the start time of the channel access window comprises:
determining a deterministic part proportional to a time interval employed in the wireless network;
determining a random or pseudo-random part; and
computing the start time of the channel access window from the deterministic part and the random or pseudo-random part.

4. The method of claim 3, wherein random or pseudo-random part are determined from at least one of an identifier of the terminal device, an identifier of the access node, and an identifier of the wireless network.

5. The method of claim 3, wherein deterministic part is comprised in the received scanning message.

6. The method of claim 3, wherein the time interval employed in the wireless network is a beacon period.

7. The method of claim 1, further comprising determining transmission timing within the channel access window, wherein the transmission timing is based on a random or pseudo-random value.

8. The method of claim 1, further comprising determining a length of the channel access window from at least one information element of the scanning frame.

9. The method of claim 1, further comprising determining an access category for the link setup request frame from at least one information element of the scanning frame, wherein the access category specifies a priority level of the link setup request frame.

10. The method of claim 1, further comprising using the link setup request frame to request at least one of the following: to authenticate the terminal device in the access node; to create an association between the access node and the terminal device for frame transmissions; and to request, upon determining from the scanning frame that the access node has downlink data buffered for transmission to the terminal device, the access node to transmit at least one downlink data frame to the terminal device.

11. A method comprising:
monitoring, in an access node of a wireless network, channel activity of a radio channel employed in the wireless network;
determining at least one timing control parameter on the basis of the monitored channel activity, wherein a value of the at least one timing control parameter controls timing of at least one channel access window employed by at least one terminal device in transmission of a link setup request frame; and
causing transmission of a frame comprising an information element carrying said at least one timing control parameter.

12. The method of claim 11, further comprising:
determining an access category for said link setup request frame on the basis of the monitored channel activity, wherein the access category defines a priority of the link setup request frame;
and inserting said access category in the frame.

13. The method of claim 11, further comprising:
determining at least one timing control parameter that controls delay of a trigger frame, wherein the trigger frame is employed by a terminal device to initiate a contention-free period for transferring at least one data frame between the terminal device and the access node; and
inserting said timing control parameter that controls the delay of the trigger frame into the frame.

14. An apparatus comprising:
at least one processor; and
at least one memory including a computer program code, wherein the at least one memory and the computer program code are configured, with the at least one processor, to cause the apparatus to:
acquire a scanning frame originating from an access node and indicating availability of a wireless network;
upon acquiring the scanning frame, determining a start time of a channel access window as a random or pseudo-random value; and
cause transmission of a link setup request frame to the access node during the determined channel access window.

15. The apparatus of claim 14, wherein the at least one memory and the computer program code are configured, with the at least one processor, to cause the apparatus to determine the start time of the channel access window by using a value of at least one information element of the received scanning frame.

16. The apparatus of claim 14, wherein the at least one memory and the computer program code are configured, with the at least one processor, to cause the apparatus to determine the start time of the channel access window by:
determining a deterministic part proportional to a time interval employed in the wireless network;
determining a random or pseudo-random part; and
computing the start time of the channel access window from the deterministic part and the random or pseudo-random part.

17. The apparatus of claim 16, wherein the at least one memory and the computer program code are configured, with the at least one processor, to cause the apparatus to determine the random or pseudo-random part from at least one of an identifier of the apparatus, an identifier of the access node, and an identifier of the wireless network.

18. The apparatus of claim 16, wherein deterministic part is comprised in the scanning message.

19. The apparatus of claim 16, wherein the time interval employed in the wireless network is a beacon period.

20. The apparatus of claim 14, wherein the at least one memory and the computer program code are configured, with the at least one processor, to cause the apparatus to determine transmission timing within the channel access window, wherein the transmission timing is based on a random or pseudo-random value.

21. The apparatus of claim 14, wherein the at least one memory and the computer program code are configured, with the at least one processor, to cause the apparatus to determine a length of the channel access window from at least one information element of the scanning frame.

22. The apparatus of claim 14, wherein the at least one memory and the computer program code are configured, with the at least one processor, to cause the apparatus to determine an access category for the link setup request frame from at least one information element of the scanning frame, wherein the access category specifies a priority level of the link setup request frame.

23. The apparatus of claim 14, wherein the at least one memory and the computer program code are configured, with the at least one processor, to cause the apparatus to use the link setup request frame to request at least one of the following: to authenticate the apparatus in the access node; to create an association between the access node and the apparatus for frame transmissions; and to request, upon determining from the scanning frame that the access node has downlink data buffered for transmission to the apparatus, the access node to transmit at least one downlink data frame to the apparatus.

24. The apparatus of claim 14, further comprising radio interface components providing the apparatus with radio communication capability.

25. An apparatus comprising:
at least one processor; and
at least one memory including a computer program code, wherein the at least one memory and the computer program code are configured, with the at least one processor, to cause the apparatus to:
monitor channel activity of a radio channel employed in a wireless network;
determine at least one timing control parameter on the basis of the monitored channel activity, wherein a value of the at least one timing control parameter controls timing of at least one channel access window employed by at least one terminal device in transmission of a link setup request frame; and
cause transmission of a frame comprising an information element carrying said at least one timing control parameter.

26. The apparatus of claim 25, wherein the at least one memory and the computer program code are configured, with the at least one processor, to cause the apparatus to:
determine an access category for said link setup request frame on the basis of the monitored channel activity, wherein the access category defines a priority of the link setup request frame; and
insert said access category in the frame.

27. The apparatus of claim 25, wherein the at least one memory and the computer program code are configured, with the at least one processor, to cause the apparatus to:
determine at least one timing control parameter that controls delay of a trigger frame, wherein the trigger frame is employed by a terminal device to initiate a contention-free period for transferring at least one data frame between the terminal device and the access node; and
insert said timing control parameter that controls the delay of the trigger frame into the frame.

28-29. (canceled)
